(19) United States
(12) Patent Application Publication
(10) Pub. No.: US 2016/0076593 A1
(43) Pub. Date: Mar. 17, 2016

(54) NEEDLE ROLLER CAGE WITH OIL SLOTS

(71) Applicant: Schaeffler Technologies AG & Co. KG, Herzogenaurach (DE)

(72) Inventor: Dennis ROFFE, Fort Mill, SC (US)

(73) Assignee: SCHAEFFLER TECHNOLOGIES AG & CO. KG, Herzogenaurach (DE)

(21) Appl. No.: 14/809,491

(22) Filed: Jul. 27, 2015

Related U.S. Application Data
(60) Provisional application No. 62/050,820, filed on Sep. 16, 2014.

(51) Int. Cl. F16C 33/66

(52) U.S. Cl. CPC F16C 33/6681

(57) ABSTRACT

A roller bearing cage and a roller bearing assembly are provided. The roller bearing cage has a cylindrical body formed with a plurality of pockets and a first cage rim at a first axial end of the body, the first cage rim including one or more axial passages. The cage has a second cage rim at a second axial end of the body, the second cage rim including one of more second axial passages.

### INCORPORATION BY REFERENCE

The following document is incorporated herein by reference as if fully set forth: U.S. Provisional Patent Application No. 62/050,820 filed Sep. 16, 2014.

### FIELD OF INVENTION

Embodiments of the present invention generally relate to roller bearing assemblies.

### BACKGROUND

Some roller bearings include cylindrical rolling elements, or needle bearings, held in circumferential position in a cage. In some needle roller bearing applications, an axial flow of lubricant may be provided to the rolling elements to enhance bearing performance. In certain applications, portions of the cage impede the flow of lubricant into the cage pockets and rolling elements.

Accordingly, a need exists for a roller bearing cage that facilitates oil flow to the rolling elements.

### SUMMARY

Embodiments of a roller bearing cage and a roller bearing assembly are provided herein. In some embodiments, the roller bearing cage comprises a cylindrical body formed with a plurality of pockets with a first cage rim at a first axial end of the body, the first cage rim including one or more first axial passages. The cage comprises a second cage rim at a second axial end of the body, the second cage rim including one of more second axial passages.

In some embodiments, a roller bearing assembly comprises a cylindrical body formed with a plurality of pockets having a first cage rim at a first axial end of the body, the first cage rim including one or more first axial passages and a second cage rim at a second axial end of the body, the second cage rim including one of more second axial passages. Cylindrical rollers are disposed in at least some of the pockets.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 partial axial view of an embodiment of a roller bearing cage in accordance with an embodiment of the disclosure.

FIG. 2 is a top view of the roller bearing cage of FIG. 6 taken along II-II.

FIGS. 3A, 3B, and 3C cross sectional views of a roller bearing cage in accordance with the present disclosure.

FIG. 4 is a partial axial view of an embodiment of a roller bearing assembly in accordance with an embodiment of the disclosure.

FIG. 5 is a perspective view of a roller bearing cage in accordance with an embodiment of the present disclosure.

FIG. 6 is a perspective view of a roller bearing assembly in accordance with an embodiment of the present disclosure.

FIG. 7 is a top view of a portion of a roller bearing cage on accordance with this disclosure in a flattened form.

To facilitate understanding, identical reference numerals have been used, where possible, to designate identical elements that are common in the figures. The figures are not drawn to scale and may be simplified for clarity. It is contemplated that elements and features of one embodiment may be beneficially incorporated in other embodiments without further recitation.

### DETAILED DESCRIPTION

Certain terminology is used in the following description for convenience only and is not limiting. The words “front,” “rear,” “upper” and “lower” designate directions in the drawings to which reference is made. The words “radially inwardly” and “radially outwardly” refer to directions radially toward and away from an axis of the part being referenced. “Axially” refers to a direction along the axis of a shaft or other part. The terminology includes the words specifically noted above, derivatives thereof and words of similar import.

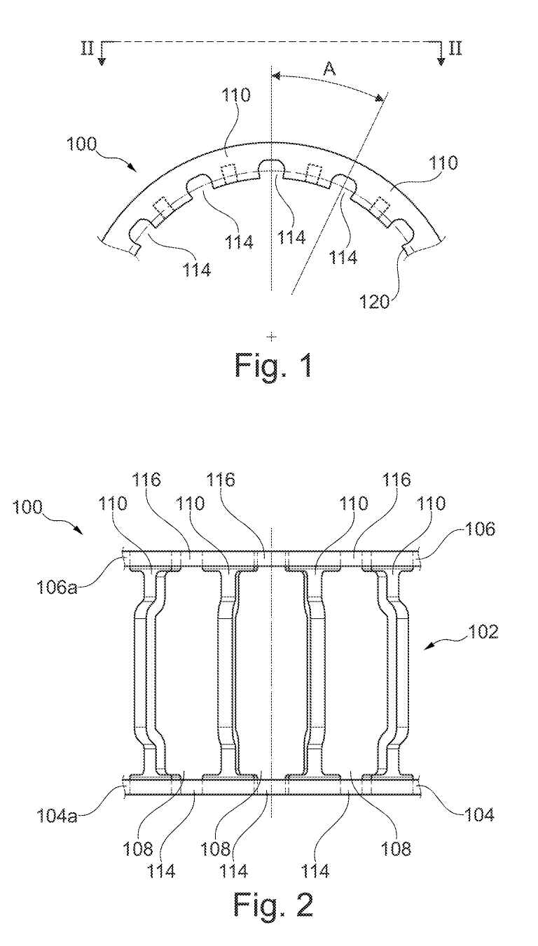

A roller bearing cage 100 according to embodiments disclosed herein may be understood from the figures, for example from FIGS. 1, 2, and 5. The roller bearing cage 100 includes a cylindrical body 102 and first and second cage rims 104, 106 at first and second axial ends 104a, 106a of the cylindrical body 102. The cylindrical body 102 includes pockets 108 bounded by the cage rims 104, 106 and adjacent cage bars 110.

In the non-limiting embodiment of FIGS. 1 and 2, first and second axial passages 114, 116 are formed in the first and second cage rims 104, 106, respectively. As illustrated in FIG. 1, axial passages 114 are uniformly distributed around an inner perimeter 120 of the first cage rim 104 of the roller bearing cage 100, with adjacent axial passages 114 angularly spaced by an angle A. In a preferred embodiment, the second axial passages 116 are similarly formed as first axial passages 114 and may be angularly positioned with the same angular spacing. In a preferred embodiment, the first and second axial passages 114, 116 and the pocket 108 formed therebetween are aligned, that is positioned with the same angular displacement around the roller bearing cage 100.

In the non-limiting embodiment illustrated in FIGS. 1, 2, and 5, each pocket 108 has a first and second axial passage 114, 116 formed through the portion of the first and second cage rim 104, 106 bounding the pocket 108. In other embodiments, some pockets may have only one axial passage, or may have no axial passages, through the cage rim portion bounding the pocket.

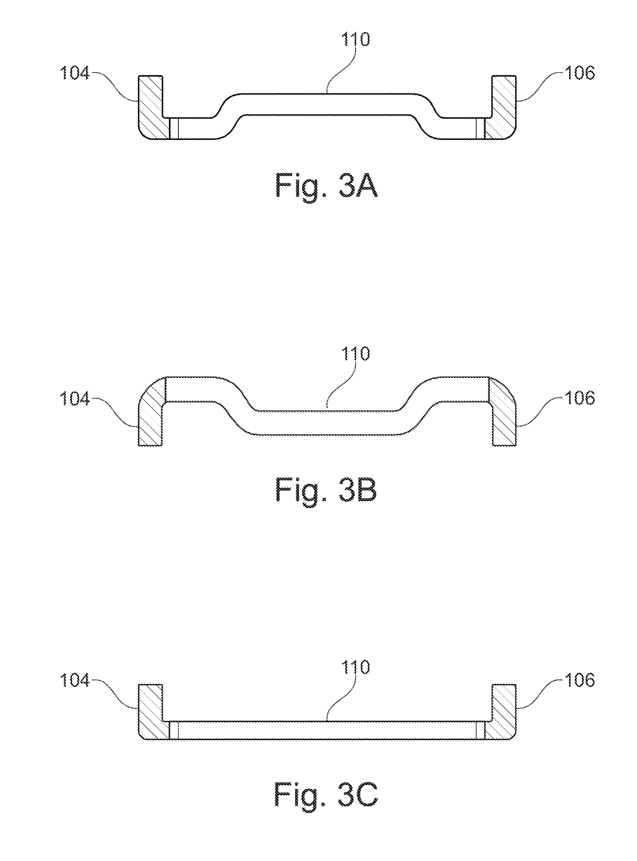

In cross section, the cage rims 104, 106 and cage bars 110 may have a variety of profiles. For example, as drawn in FIGS. 1, 2, and 5, the cage bars have a “W” profile as may be better understood from the cross section of FIG. 3A. Other profiles may include the “M” profile illustrated in FIG. 3B and the “U” profile illustrated in FIG. 3C.

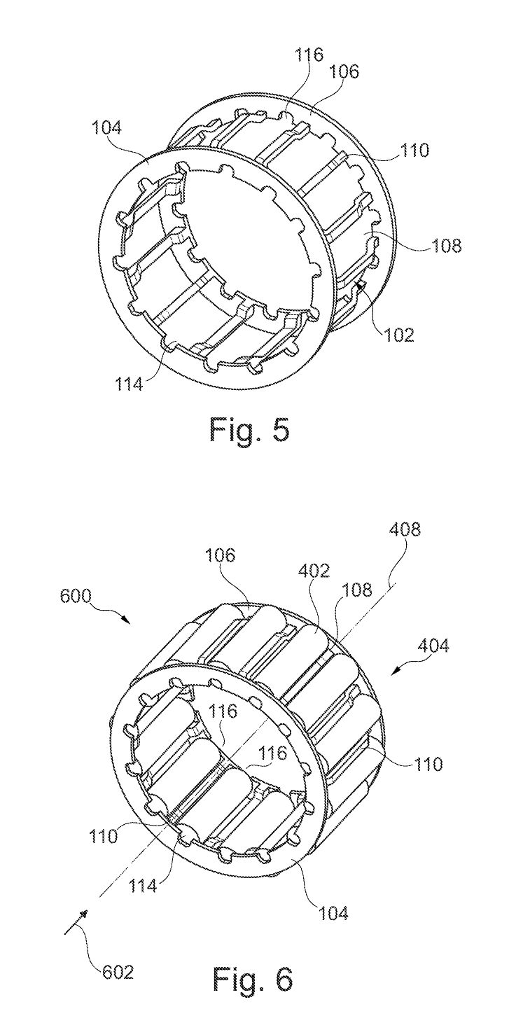

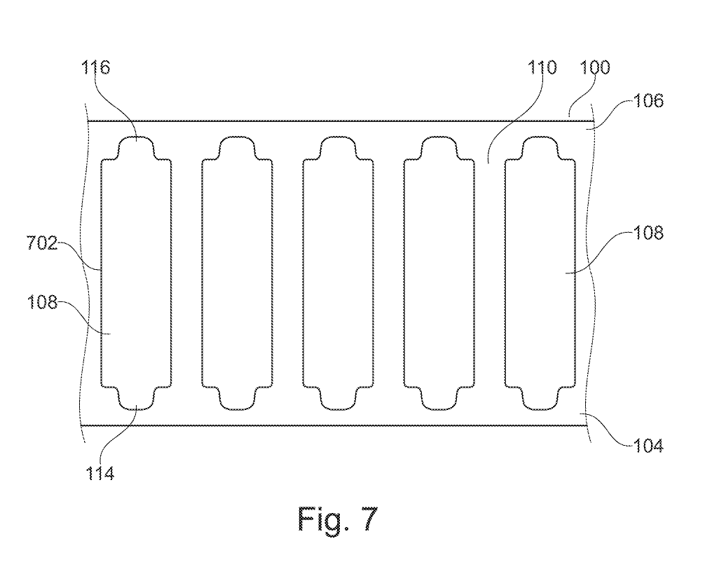

In a preferred embodiment, a common wall forms the periphery of the first axial passage, the second axial passage, and the pocket. For example, FIG. 7 represents a portion of the roller bearing cage 100 in a flattened form. As illustrated, cage rims 104, 106 and cage bars 110 are coplanar. Axial passages 114, 116 and pocket 108 formed therebetween are formed by common wall 702. For example, a strip of material having a width and length suitable for a roller bearing cage may by punched formed to create the pocket and associated axial passages, pressed to form a profile, for example as illustrated in FIGS. 3A-3C, and formed into a roller bearing cage as illustrated in FIG. 5.

Each roller bearing cage profile (e.g., W, M, and U) is configured to retain a rolling element, for example a cylindrical or needle roller, within the pocket 108, forming a roller bearing assembly 400, 600. In the roller bearing assemblies in accordance with this disclosure, rolling elements 402 are disposed around the circumference of a roller bearing cage 404 within pockets 108. Cage bars 110 separate adjacent pockets 108 and may maintain circumferential separation of rolling elements 402.

The roller bearing cage 404 in roller bearing assembly 400 may be any known profile discussed above.

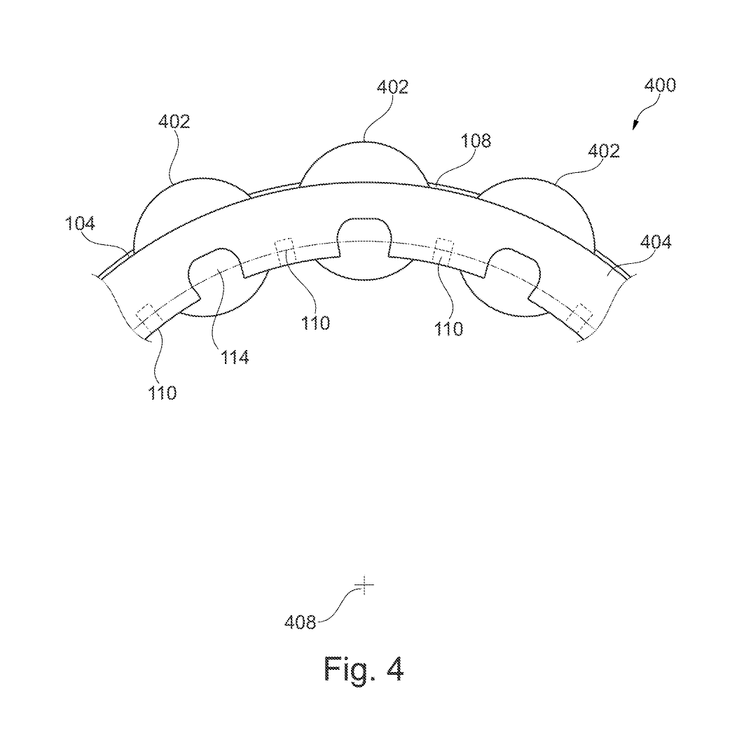

Roller bearing assemblies may be provided with an axial flow of lubricant to lubricate contact points in the bearing. As illustrated in FIGS. 4 and 6, the axial flow (represented by arrow 602) is aligned with the central axis 408 of the cage 404. As may be seen in FIG. 6, when first and second axial passages 114, 116 and the pocket 108 formed therebetween are aligned, an axial path may be formed through the first axial passage 114, along the outer surfaces of the rolling element, and through the second axial passage 116. The axial passages 114, 116 and the pocket 108 may cooperate to provide passages for conducting a fluid flow, for example a lubricant flow, through the roller bearing assembly 400. The axial passages 114, 116 may beneficially provide an enhanced flow of lubricating fluid to the rolling elements 402.

Thus a roller bearing cage and roller bearing assembly are provided herein. The disclosed roller bearing cage and roller bearing assembly may advantageously reduce wear, decreased bearing noise during use, or reduced power transmission loss.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A roller bearing cage comprising:
a cylindrical body formed with a plurality of pockets;
a first cage rim at a first axial end of the body, the first cage rim including first axial passages; and
a second cage rim at a second axial end of the body, the second cage rim including second axial passages.

2. The cage of claim 1, wherein the first axial passages are distributed around an inner perimeter of the first cage rim and the second axial passages are distributed around an inner perimeter of the second cage rim.

3. The cage of claim 2, wherein the first axial passages are uniformly angularly spaced apart and the second axial passages are uniformly angularly spaced apart.

4. The cage of claim 2 wherein the first and the second axial passages and a pocket formed therebetween are positioned with the same angular displacement around the roller bearing cage.

5. The cage of claim 1, wherein a common wall forms a periphery of the first axial passage, the second axial passage, and a pocket formed therebetween.

6. A roller bearing assembly comprising:
a roller bearing cage having a cylindrical body formed with a plurality of pockets;
a first cage rim at a first axial end of the body, the first cage rim including first axial passages; and
a second cage rim at a second axial end of the body, the second cage rim including second axial passages; and
cylindrical rollers disposed in at least some of the pockets.

7. The assembly of claim 6, wherein the first axial passages are distributed around an inner perimeter of the first cage rim and the second axial passages are distributed around an inner perimeter of the second cage rim.

8. The assembly of claim 7, wherein the first axial passages are uniformly angularly spaced apart and the second axial passages are uniformly angularly spaced apart.

9. The assembly of claim 7, wherein the first and second axial passages and a pocket formed therebetween are positioned with the same angular displacement around the roller bearing cage.

10. The assembly of claim 6, wherein a common wall forms a periphery of the first axial passage, the second axial passage, and one of the plurality of pockets.

11. The assembly of claim 6, wherein a first axial passage, a second axial passage and a pocket formed therebetween provides a passage for conduction a fluid flow through the assembly.
